(19) United States
(12) Patent Application Publication
(10) Pub. No.: US 2016/0070491 A1
(43) Pub. Date: Mar. 10, 2016

(54) INFORMATION PROCESSOR, COMPUTER-READABLE RECORDING MEDIUM IN WHICH INPUT/OUTPUT CONTROL PROGRAM IS RECORDED, AND METHOD FOR CONTROLLING INPUT/OUTPUT

(71) Applicant: FUJITSU LIMITED, Kawasaki-shi (JP)

(72) Inventor: Yohsuke Takada, Kawasaki (JP)

(21) Appl. No.: 14/811,931

(22) Filed: Jul. 29, 2015

(30) Foreign Application Priority Data
Sep. 10, 2014 (JP) 2014-184113

(51) Int. Cl. G06F 3/06

(52) U.S. Cl. CPC G06F 3/0619; G06F 3/0689; G06F 3/0665; G06F 3/0653; G06F 3/0658

(57) ABSTRACT

An I/O controller simultaneously performs first I/O control on a plurality of storing devices, which configure a redundant system, in accordance with a first I/O request from an upper application. An response processor outputs, when the response processor receives a process completion notification from a first storing device that is one of the plurality of storing devices as a result of the first I/O control simultaneously performed on the plurality of storing devices, a completion response representing completion of a process related to the first I/O request to the upper application. This configuration makes it possible to rapidly respond to the I/O control of the upper application with a process completion and to reduce the time length occupied by the I/O control of the upper application.

### CROSS-REFERENCE TO RELATED APPLICATION

This application is based upon and claims the benefit of priority of the prior Japanese Application No. 2014-184113 filed on Sep. 10, 2014 in Japan, the entire contents of which are hereby incorporated by reference.

### FIELD

The present invention relates to an information processor, a computer-readable recording medium in which an input/output control program is recorded, and a method for controlling input/output.

### BACKGROUND

In an information processing system including an information processor and a storing device, the information processor issues an input/output request to the storing device and makes reading and writing accesses to data in the storing device. Here, an example of the information processor is a server and a personal computer; an example of an input/output request is a writing command and a reading command, and is issued by executing an application program in the information processor. Hereinafter, input/output is sometimes abbreviated to “I/O”, and the application program is sometimes referred to as an “application”.

It is known to the art that such an information processing system adopts a redundant storage configuration that multiple storing devices achieve by means of mirroring in order to improve the tolerance to a disk failure in the storage device. In an event of an I/O error due to a failure in a disk of a redundant storage configuration by means of mirroring, the failure disk is fallen back and the information processing system continues its operation using the normal disk serving as the counterpart of the fallback disk.

For example, description will now be made in relation to operation in an information processing system including two of redundant disks (storing devices), which configure a redundant system, when an I/O error occurs in one of the two disks with reference to FIG. 14. In the example of FIG. 14, both disks 201 and 202 configuring a redundant system are working (in the operating state). In other words, the disks 201 and 202 forming a redundant system are both in the active state. This state is referred to as “active-active”.

As illustrated in FIG. 14, the disks 201 and 202 are connected to a server 100. The Central Processing Unit (CPU) 101 of the server 100 executes an application 110. The CPU 101 functions as a disk manager 120 by executing disk managing software. The CPU 101 also functions as the disk drivers 131 and 132 provided for the disks 201 and 202, respectively, by executing driver software.

In the information processing system of FIG. 14, the application 110 issues an I/O request to the disk manager 120 (see Arrow A1). Upon receipt of the I/O request from the application 110, the disk manager 120 issues an I/O request concurrently to the two disks 201 and 202 via the disk drivers 131 and 132, respectively (see Arrows A2a and A2b). Upon receipt of a process completion notification from the corresponding disk 201, the disk driver 131 notifies disk manager 120 of I/O completion (see Arrow A3).

At that time, if the other disk 202 is also normal, the disk 202 replies to the disk driver 132 with a process completion notification and responsively, the disk driver 132 notifies disk manager 120 of I/O completion. Then the disk manager 120, which has received an I/O completion notification from both the disk drivers 131 and 132, notifies the application 110 of I/O completion.

In contrast, when an I/O error occurs in the disk 202 as illustrated in FIG. 14, the disk 202 is not able to reply to the disk driver 132 with an I/O completion notification. At this time, the disk driver 132 comes into a state of waiting for an I/O completion notification from the disk 202 and stands by for retrying a predetermined number of times or for time out of a predetermined time period. When retrying a predetermined number of times has been executed or a predetermined time period for standing by expires (see Symbol A4: “I/O retransmission over”), the disk driver 132 notifies the disk manager 120 of an I/O error (see Arrow A5).

Upon receipt of the notification of the I/O error from the disk driver 132, the disk manager 120 falls back the disk 202 and disconnects the disk 202 from the information processing system (see Arrow A6). Then, the disk manager 120 notifies the application 110 of I/O completion. This means that, if an I/O error occurs in one of two disks 201 and 202 in an active-active information processing system, the operation of the system continues without a halt.

Japanese Laid-open Patent Publication No. 09-171441 discloses a system including a working storing device and a spare storing device, in which system a processor (e.g., a server) accesses the working storage device during normal operation. The working storage device exchanges the spare storing device with, for example, commands and thereby mirroring is carried out between the two storing devices. Accordingly, it can be said that one of the storing devices configuring a redundant system is working (in the working state; active) and the other is in the waiting (standing-by) state, so that the system is referred to as an “active-stand-by” system in contrast to the above “active-active” system. The configuration of an active-active system is different from that of an active-stand-by system, as described above. Even when a failure occurs in one of the storing device, an active-active system is capable of continuing its operation without a halt using the other storing device. In contrast, in the event of such a failure, an active-stand-by system needs to halt its operation during the switch from the working system to the standing-by system. Furthermore, the object of the technique disclosed in the publication is to reduce the overhead of the working storing device, but is not to shorten the response time to an I/O request when a failure occurs in the working storing device.

As described above, in the information processing system of FIG. 14, when the disk 202 has a failure and does not issue an I/O response, the disk driver 132 carries out retrying or standing-by until time out and then replies to the application 110 with an I/O error. However, the disk driver comes into a state of no I/O response during retrying of standing-by until time out, which means the system operation halts. In other words, the disk driver delays a processing completion response to the I/O control according to the I/O request from the upper application and the I/O control of the upper application (during which the operation halts) takes a long time.

Such a halt of the information processing system costs the system as much as the time of the halt. For the above, when an I/O response from a disk delays, the art demands for a solution that the disk driver does not wait for the response too long and the failure disk is rapidly disconnected to possibly shorten a halt of the operation.

In accordance with recent spread of big data, the number of disks provided for individual system has largely increased. The growth of the number of disks accompanies increase in occurrence of disk failure. To improve the reliability of disks and to shorten the time for operation halt due to a disk failure are regarded as important issues.

Furthermore, since the performance of servers have also been enhanced in accordance with the improvement of the performances of CPUs and memories, a demand for the I/O performance of a disk has been heightened. Accordingly, it is desired to possibly shorten the time needed for a process completion response to the I/O control by the upper application.

In cases where an information processing system uses a versatile disk as a storing device, the configuration of the disk is not changed. Therefore, it is desired to speed up a process completion notification at an entity higher than the disk.

### SUMMARY

According to an aspect of the embodiment, an information processor includes an input/output (I/O) controller and a response processor. The I/O controller simultaneously performs first I/O control on a plurality of storing devices, which configure a redundant system, in accordance with a first I/O request from an upper application. The response processor outputs, when the response processor receives a process completion notification from a first storing device that is one of the plurality of storing devices as a result of the first I/O control simultaneously performed on the plurality of storing devices, a completion response representing completion of a process related to the first I/O request to the upper application.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram schematically illustrating hardware and functional configurations of an information processing device according to a first embodiment of the present invention;

FIG. 2 is a diagram illustrating an example of volume configuration and state management information of the first embodiment;

FIG. 3 is a diagram illustrating an example of difference information (in the form of a bitmap) of the first embodiment;

FIG. 4 is a diagram illustrating operation of the first embodiment when two disks configuring a redundant system are both normal;

FIG. 5 is a diagram illustrating operation of the first embodiment when one of the two disks configuring a redundant system has a failure;

FIG. 6 is a diagram illustrating operation of the first embodiment when the other of the two disks configuring a redundant system has a failure;

FIG. 7 is a diagram illustrating more detailed operation of the first embodiment when one of the two disks configuring a redundant system has a failure;

FIG. 8 is a diagram illustrating specific operation for restoring from tentative fallback in the first embodiment;

FIG. 9 is a block diagram schematically illustrating specific operation of the disk manager of the first embodiment;

FIG. 10 is a flow diagram denoting a succession of procedural steps of issuing an I/O request to a disk driver of the first embodiment;

FIG. 11 is a flow diagram denoting a succession of procedural steps performed by a disk manager for a writing process in the first embodiment;

FIG. 12 is a flow diagram denoting a succession of procedural steps performed by a disk manager for a reading process in the first embodiment;

FIG. 13 is a flow diagram denoting a succession of procedural steps of processing a tentative fallback restoring thread of the first embodiment; and

FIG. 14 is a diagram illustrating operation of an information processing system when one of two redundant disks has an I/O error.

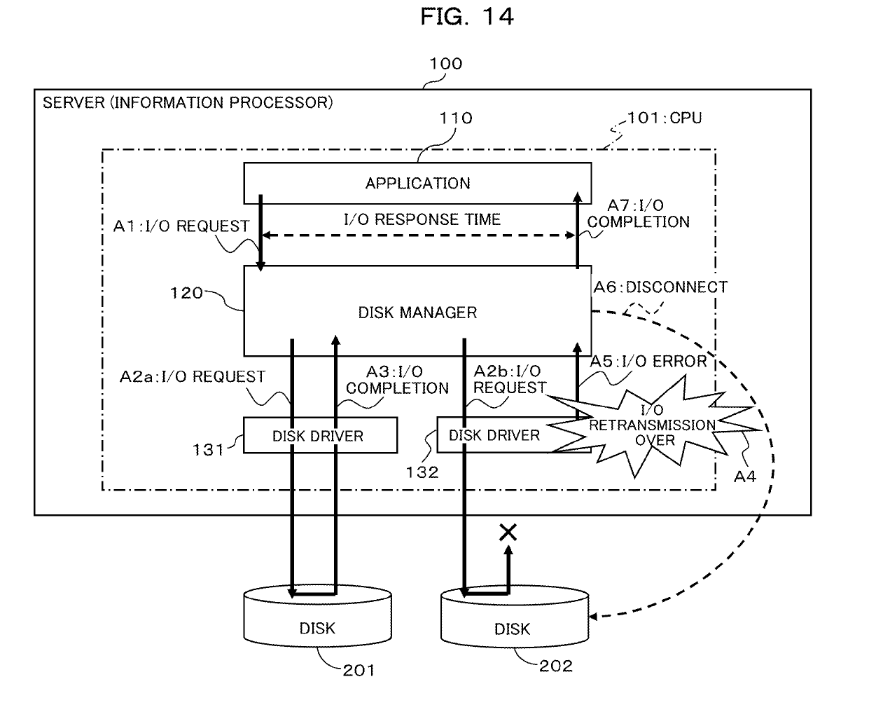

### DESCRIPTION OF THE PREFERRED EMBODIMENTS

Hereinafter, description will now be made in relation to an information processor, a computer-readable recording medium in which an I/O controlling program is recorded, and a method for controlling I/O with reference to the accompanying drawings. However, the embodiment to be detailed below is merely an example and does not intend to exclude another modification and application of techniques that are not referred in this description. In other words, various changes and modification can be suggested without departing from the gist of the embodiment. The accompanying drawings may include other elements and functions in addition to those in the drawings. Besides, the embodiment and the modification can be combined without contradiction in process to each other.

(1) The Configuration of a First Embodiment:

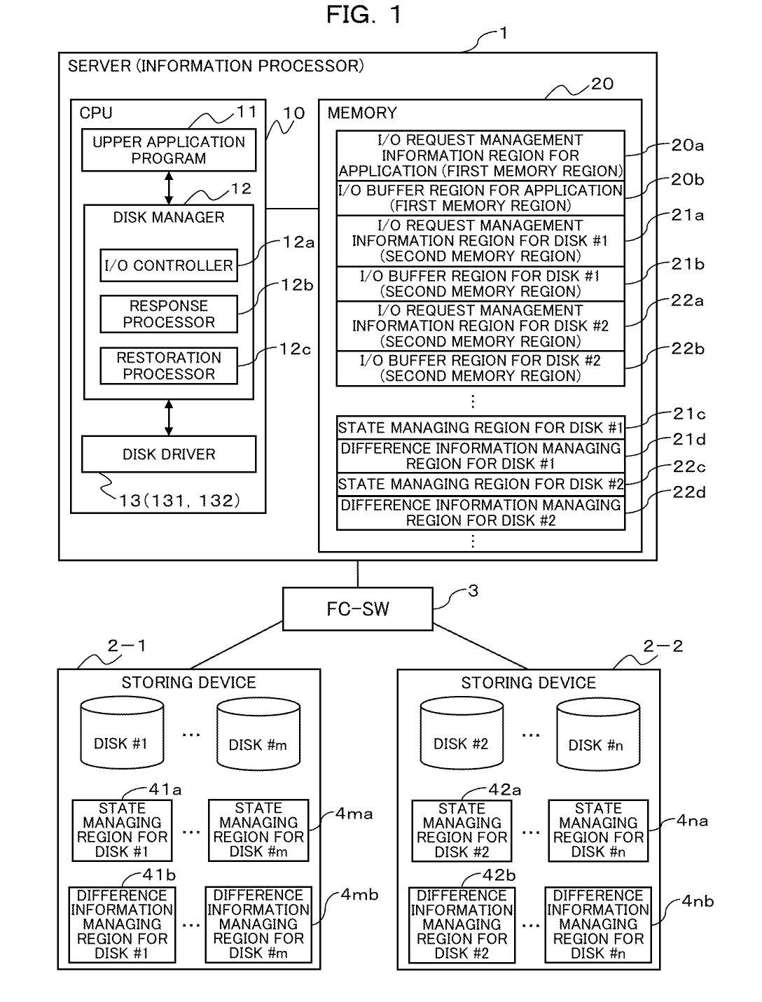

First of all, description will now be made in relation to the hardware and functional configurations of an information processor 1 according to a first embodiment of the present invention with reference to block diagram FIG. 1.

In the first embodiment, there are provided a server 1 serving as the information processor and multiple (two in the first embodiment) storing devices 2-1 and 2-2, which configure a redundant system. Hereinafter, the two storing devices are discriminated from each other by reference numbers 2-1 and 2-2 while an arbitrary storing device is represented by reference number 2.

In the example of FIG. 1, the storing devices 2 are external hardware to the server 1, but may alternatively be incorporated in the server 1. Each storing device 2 may include multiple Hard Disk Drives (HDDs), Solid State Drives (SSDs), or may form Redundant Arrays of Inexpensive Disks (RAID).

Each storing device 2 includes multiple HDDs. Specifically, the storing device 2-1 includes a disk #1, . . . , and a disk #m and the storing device 2-2 includes disk #2, . . . , the disk #n. The symbols m and n are the numbers of 3 or more. In the first embodiment, data is mirrored between the disk #1 in the storing device 2-1 and the disk #2 in the storing device 2-2. Data mirroring is carried out in a unit of a single disk or in a unit of several disks (i.e., in a unit of virtual volume).

Each storing device 2 includes a non-illustrated Controller Module (CM), which receives an I/O request from the server 1 and controls the disks in the storing device 2 in accordance with the received I/O request.

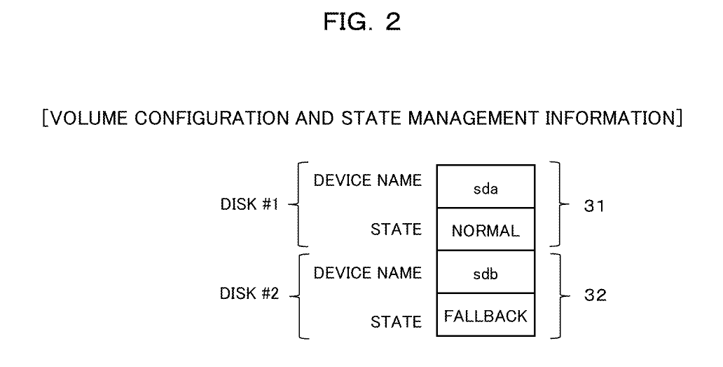

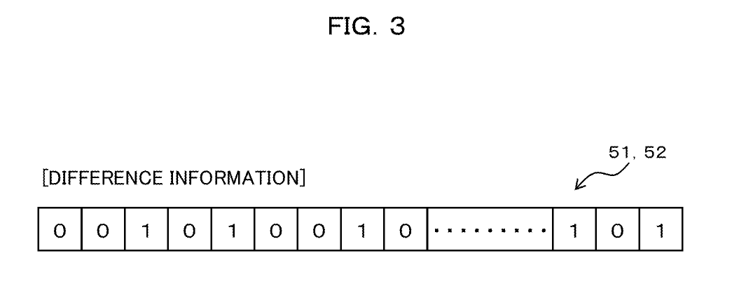

The storing device 2-1 includes state managing regions 41a, . . . , 4ma for disks #1, . . . , #m, and each of the state managing regions 41a, . . . , 4ma stores therein volume configuration and state management information 31, which will be detailed below with reference to FIG. 2. The storing device 2-1 further includes difference information managing regions 41b, . . . , 4mb for disks #1, . . . , #m, and the difference information managing regions 41b, . . . , 4mb stores therein difference information (bitmap) 51, which will be detailed below with reference to FIG. 3. The regions 41a, . . . , 4ma and the regions 41b, . . . , 4mb may be reserved in the respective corresponding disks #1, . . . , #m or may be reserved in a non-illustrated memory, such as a Random Access Memory (RAM), which is included in the storing device 2-1 and which the CM can access. The volume configuration and state management information 31 and the difference information (bitmap) 51 stored in the regions 41a, . . . , 4ma and the regions 41b, . . . , 4mb are updated by, for example, the CM of the storing device 2-1.

Likewise, the storing device 2-2 includes state managing regions 42a, . . . , 4na for disks #2, . . . , #n and each of the state managing regions 42a, . . . , 4na stores therein volume configuration and state management information 32, which will be detailed below with reference to FIG. 2. The storing device 2-2 further includes difference information managing regions 42b, . . . , 4nb for disks #2, . . . , #n, and the difference information managing regions 42b, . . . , 4nb stores therein difference information (bitmap) 52, which will be detailed below with reference to FIG. 3. The regions 42a, . . . , 4na and the regions 42b, . . . , 4nb may be reserved in the respective corresponding disks #2, . . . , #n or may be reserved in a non-illustrated memory, such as a RAM, which is included in the storing device 2-2 and which the CM can access. The volume configuration and state management information 32 and the difference information (bitmap) 52 stored in the regions 42a, . . . , 4na and the regions 42b, . . . , 4nb are updated by, for example, the CM of the storing device 2-2.

The server 1 issues an I/O request to the storing devices 2, and makes a writing access and a reading access to the data stored in the storing devices 2. Examples of the I/O request are a writing command and a reading command. The I/O request is issued by server 1 executing an upper application program 11.

The server 1 is connected to the two storing devices 2-1 and 2-2 via a Fiber Channel Switch (FC-SW) 3, so that the server 1 can simultaneously access two storing devices 2-1 and 2-2. FIG. 1 omits illustration of an interface of the server 1 with the FC-SW 3 and an interface of each storing device 2 with the FC-SW 3. The paths that enable communication between the server 1 and the respective storing devices 2-1 and 2-2 via the FC-SW 3 are a redundant multi-path, which does not appear in FIG. 1.

The server 1 includes a CPU 10 and a memory 20. The CPU 10 executes the upper application program 11. The CPU 10 further functions as a disk manager 12 by executing disk managing software (i.e., I/O controlling program). The disk manager 12 includes an I/O controller 12a, a response processor 12b, and a restoration processor 12c, which are to be detailed below. The CPU 10 further functions as a disk driver 13 (e.g., disk drivers 131 and 132 corresponding to the disks #1 and #2, respectively) by executing driver software.

The upper application program 11, the disk managing software, and the driver software that are executed by the CPU 10 are provided in the form of being recorded in a tangible and non-transitory computer-readable storage medium, such as a flexible disk, a CD (e.g., CD-ROM, CD-R, and CD-RW), a DVD (DVD-ROM, DVD-RAM, DVD-R, DVD-RW, DVD+R, DVD+RW), and a Blu-ray disk. The CPU 10 reads the program from the recording medium, and stores the read program in an internal storage device (e.g., the memory 20) or an external storage device for future use.

The memory 20 stores therein, for example, various pieces of data and the above programs. Examples of the memory 20 are a RAM, a Read Only Memory (ROM), an HDD, and an SSD.

In the memory 20, an I/O request management information region 20a for application and an I/O buffer region 20b for application are reserved according to the requirement. The regions 20a and 20b are regarded as first memory regions to process an I/O request from the upper application program 11. The regions 20a and 20b are reserved by the upper application program 11 when the upper application program 11 issues an I/O request and are released by the upper application program 11 when the upper application program 11 receives an completion response to the I/O request.

In the I/O request management information region 20a for application, management information including the I/O request from the upper application program 11 is stored. If an issued I/O request is a writing request, data to be written into the storing device 2 (i.e., disks #1 and #2) is stored in the I/O buffer region 20b for application. In contrast, if an issued I/O request is a reading request, data read from the storing device 2 (i.e., disk #1 or #2) is stored in the I/O buffer region 20b for application.

In the memory 20, an I/O request management information region 21a for the disk #1 and an I/O buffer region 21b for the disk #1 are also reserved according to the requirement. The regions 21a and 21b are regarded as second memory regions different from the first memory regions 20a and 20b. The regions 21a and 21b are reserved by the disk manager 12 when the disk manager 12 receives an I/O request to the disk #1 or #2 from the upper application program 11. In contrast, the regions 21a and 21b are released by the disk manager 12 when the disk manager 12 is issuing a completion response to the I/O request to the upper application program 11.

Into the I/O request management information region 21a for the disk #1, management information stored in the I/O request management information region 20a for application is copied by the disk manager 12. When the I/O request is a writing request, the disk manager 12 copies data that is to be written and that is stored in the I/O buffer region 20b for application into the I/O buffer region 21b for the disk #1. In contrast, when the I/O request is a reading request, the data read from the disk #1 is stored in the I/O buffer region 21b for the disk #1.

Likewise, in the memory 20, an I/O request management information region 22a for the disk #2 and an I/O buffer region 22b for the disk #2 are reserved according to the requirement. The regions 22a and 22b are also regarded as second memory regions different from the first memory regions 20a and 20b. The regions 22a and 22b are reserved by the disk manager 12 when the disk manager 12 receives an I/O request to the disk #1 or #2 from the upper application program 11. In contrast, the regions 22a and 22b are released by the disk manager 12 when the disk manager 12 is issuing a completion response to the I/O request to the upper application program 11.

Into the I/O request management information region 22a for the disk #2, management information stored in the I/O request management information region 20a for application is copied by the disk manager 12. When the I/O request is a writing request, the disk manager 12 copies data that is to be written and that is stored in the I/O buffer region 20b for application into the I/O buffer region 22b for the disk #2. In contrast, when the I/O request is a reading request, the data read from the disk #2 is stored in the I/O buffer region 22b for the disk #2.

In the memory 20, a state managing region 21c for the disk #1 and a difference information managing region 21d for the disk #1 are further reserved according to the requirement. In the state information managing region 21c for the disk #1, the disk manager 12 stores volume configuration and state management information 31 (see FIG. 2) for the disk #1 stored in the state managing region 41a for the disk #1 the storing device 2-1. In the difference information managing region 21d for the disk #1, the disk manager 12 also stores difference information (bitmap) 51 (see FIG. 3) for the disk #1 stored in the different information managing region 41b for the disk #1 of the storing device 2-1.

Likewise, in the memory 20, a state managing region 22c for the disk #2 and a difference information managing region 22d for the disk #2 are reserved according to the requirement. In the state information managing region 22c for the disk #2, the disk manager 12 stores volume configuration and state management information 32 (see FIG. 2) for the disk #2 stored in the state managing region 42a for the disk #2 of the storing device 2-2. In the difference information managing region 22d for the disk #2, the disk manager 12 also stores difference information (bitmap) 52 (see FIG. 3) for the disk #2 stored in the difference information managing region 42b for the disk #2 of the storing device 2-2.

Description will now be made in relation to the volume configuration and state management information 31 and 32 and the difference information (bitmaps) 51 and 52 by referring to FIGS. 2 and 3. FIG. 2 is a diagram illustrating an example of the volume configuration and state management information 31 and 32; and FIG. 3 is a diagram illustrating an example of the difference information (bitmaps) 51 and 52.

As illustrated in FIG. 2, the volume configuration and state management information includes a device name and a device state for each disk. Here, the device name is recognized by the Operating System (OS) to specify a target disk; and the device state is a value representing the state of a disk specified by the disk name. A device state takes a value corresponding to one among the following four states (11)-(14).

state (11): normal

state (12): copying (during data copying from a normal disk to a failure disk)

state (13): fallback (state of being disconnected from mirroring and not being a target for an I/O request)

state (14): tentative fallback (state of being disconnected from mirroring and not being a target for an I/O request, but having a possibility of recovering to a normal state; if data has been written into a volume under the presence of a disk in the tentative fallback state, the position information representing the position into which the data has been written is stored as the difference information into the bitmaps 51 and 52 to be detailed below).

In FIG. 2, in the volume configuration and state management information 31, the device name and the state of the disk #1 are set to be “sda” and “normal”, respectively. This volume configuration and state management information 31 is stored in the state managing region 41a for the disk #1 in the storing device 2-1 and the state information managing region 21c for the disk #1 in the memory 20. Likewise, in volume configuration and state management information 32, the device name and the state of the disk #2 are set to be “sdb” and “fallback”, respectively. This volume configuration and state management information 32 is stored in the state managing region 42a for the disk #2 in the storing device 2-2 and the state managing region 22c for the disk #2 in the memory 20.

As described above, the difference data is position information representing, if data has been written (writing access) under the presence of a disk in the tentative fallback state, the position into which the data is written. Specifically, the difference information 51 or 52 for the disk #1 or #2 are recorded in the form of a bitmap as depicted in FIG. 3.

This means that the bitmaps 51 and 52 manage, if a disk in the tentative fallback state is present, the position into which data is written and which position is included in a volume of a disk of the mirroring counterpart of the disk in the tentative fallback state. For example, providing that the disk #2 is in the tentative fallback state, the position of a volume into which data is written on the disk #1, which serves as the mirroring counterpart of the disk #2, is managed by the bitmap 51.

In this event, it is assumed that each individual bit in the bitmaps 51 and 52 manages data of a 1-MB volume, for example. Accordingly, the k-th bit in the bitmap manages whether or not data has been written into a region of a 1-MB volume in the offset (k−1) MB through k MB-1B. If data has been written into the region, the value “1” is set in the k-th bit while if data has not been written into the region, the value “0” is set in the k-th bit. As to be detailed below, data in a volume region corresponding to a bit set to be “1” is copied from a normal disk to a disk in the tentative fallback state when the disk in the tentative fallback state is restored.

Next, the functions of the I/O controller 12a, the response processor 12b, and the restoration processor 12c included in the disk manager 12 will now be described.

The I/O controller 12a performs I/O control simultaneously on two storing devices 2-1 and 2-2 (i.e., disks #1 and #2) configuring a redundant system in response to an I/O request from the upper application program 11. In the first embodiment, the two disks #1 and #2 having a redundant configuration are both working (working state; active state), and therefore constitute the above-described “active-active” system.

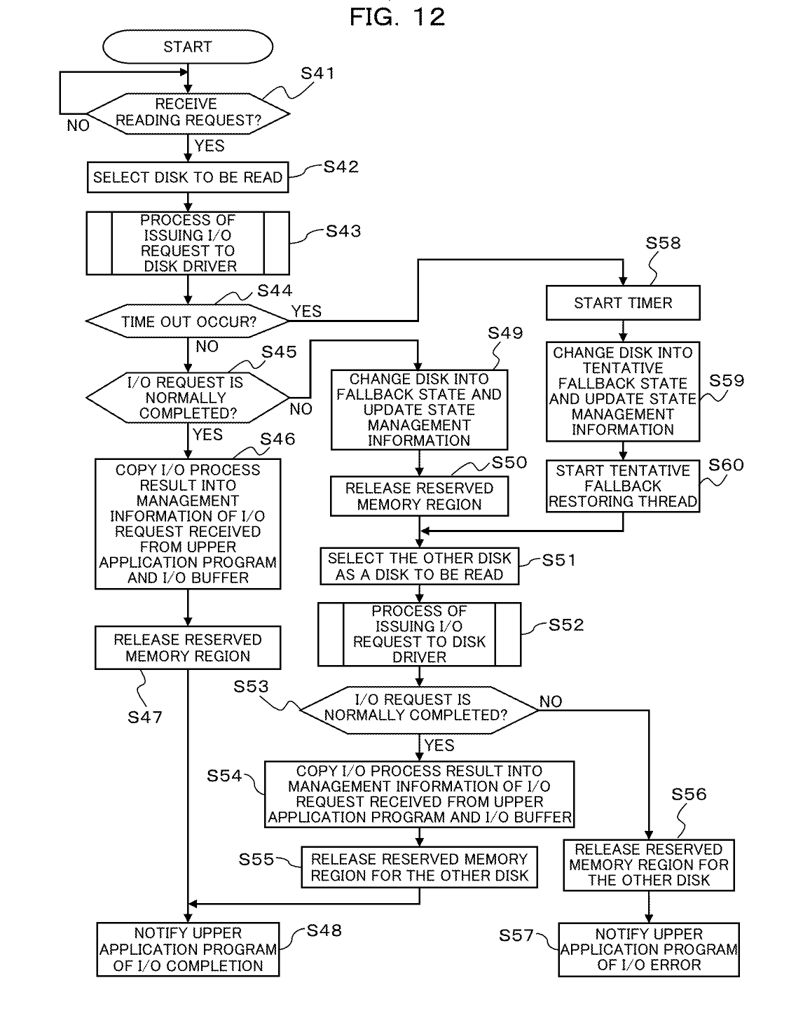

When an issued I/O request is a writing request, the two disks #1 and #2 are both regarded as the targets for the I/O request. At this time, one of the disks is determined by the upper application program 11, and a disk predetermined to be the mirroring counterpart of the disk is selected as the other disk. If the I/O request is a reading request, one of the disks determined by the upper application program 11 is regarded as the target of the I/O request, which will be detailed below by referring to FIG. 12.

If the result of the I/O control simultaneously performed on the two disks #1 and #2 satisfies the following condition, the response processor 12b outputs a completion response of the process to the I/O request to the upper application program 11. The condition is receiving a process completion notification from one (first storing device) of the two disks #1 and #2 within the first time period after the start of the I/O control and also not receiving a process completion notification from the other disk (second storing device) within the first time period. In this event, the other disk is changed into the tentative fallback state by the disk manager 12, so that the state of the other disk in the volume configuration and state management information 31 or 32 is updated into the tentative fallback state.

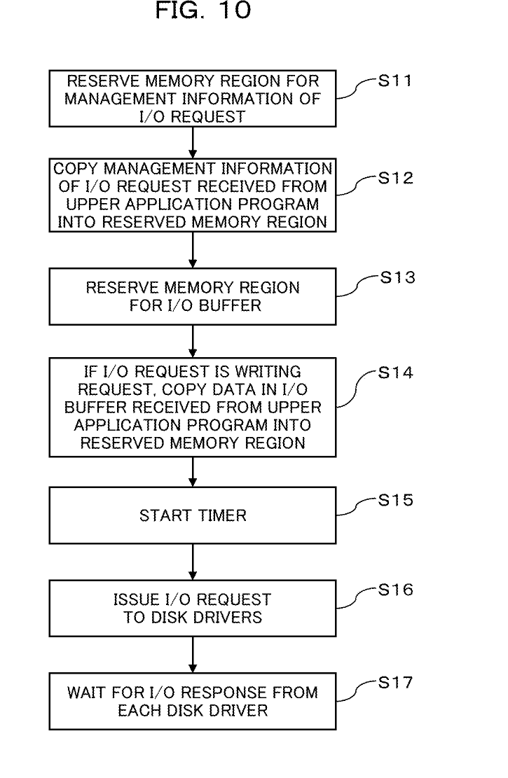

The first time period is appropriately set by a user or an operator. The first time period is counted for each disk by a timer function of the disk manager 12. The timing at which the first time period is counted, i.e., the timing of starting the timer, is the time of starting the I/O control. The time of starting an I/O control may be the time when the disk manager 12 receives the I/O request from the application 11 or the time of the end of step S14, which will be detailed below by referring to FIG. 10.

As to be described above, the I/O controller 12a reserves the second memory regions 21a, 21b, 22a, and 22b for the respective disks. The second memory regions 21a, 21b, 22a, and 22b are different from the first memory regions 20a and 20b to process an I/O request from the upper application program 11. The I/O controller 12a copies information related to the I/O request from the first memory regions 20a and 20b to the second memory regions 21a, 21b, 22a, and 22b, and further performs the I/O control on the disks via the disk driver 13, using the information copied into the second memory regions 21a, 21b, 22a, and 22b.

The disk driver 131 or 132 (i.e., the I/O controller 12a) carries out the I/O control on the other disk switched into the tentative fallback state after the first time period has passed, using the information related to the I/O request stored in the second memory regions 21a and 21b or 22a and 22b for the other disk. The I/O controller 12a carries out I/O control on the one disk in accordance with another I/O request newly issued from the upper application program 11, using information being related to the new I/O request and being stored in the second memory regions 21a and 21b or 22a and 22b for the one disk. If the I/O control according to the new I/O request is related to a writing access, the I/O controller 12a then records the position information representing a region where the writing access has been made into the bitmaps 51 and 52 of the difference information managing regions 21d, 22d, 41b and 42b.

When a process completion notification is received from the other disk within a second time period since the first time period has passed, the restoration processor 12c restores the other disk from the tentative fallback state. The state in the volume configuration and state management information 31 or 32 for the other disk is updated from the tentative fallback state to the copying state (normal state). After that, the restoration processor 12c copies difference data corresponding to a bit that is set to be “1” in the bitmap 51 or 52 from the one disk to the other disk.

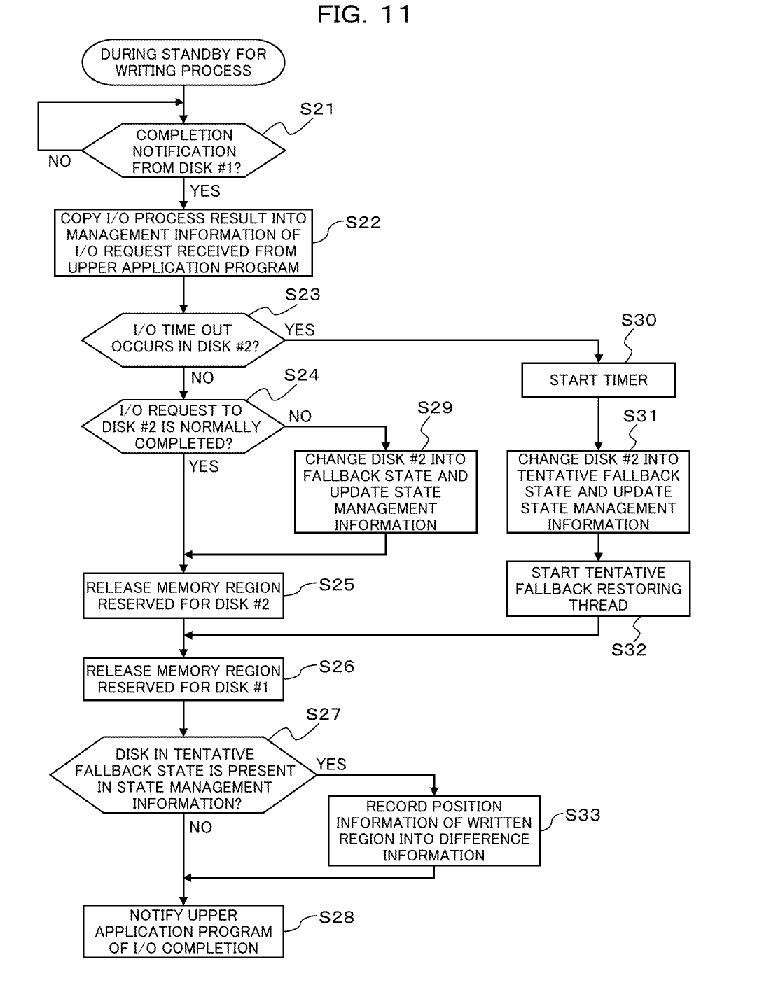

The second time period is appropriately set by a user or an operator. The second time period is counted for each disk by a timer function of the disk manager 12. The timing at which the count of the second time period is started, that is, a timing of starting the timer, is a time at which the count of the first time period is completed, which will be detailed below by referring to FIGS. 11 and 12.

On the other hand, when the process completion notification is not received from the other disk within the second time period since the first time period has passed, the restoration processor 12c changes the other disk from the tentative fallback state to the fallback state. In this event, the state in the volume configuration and state management information 31 or 32 for the other disk is updated from the tentative fallback state into the fallback state.

(2) Operation of the First Embodiment:

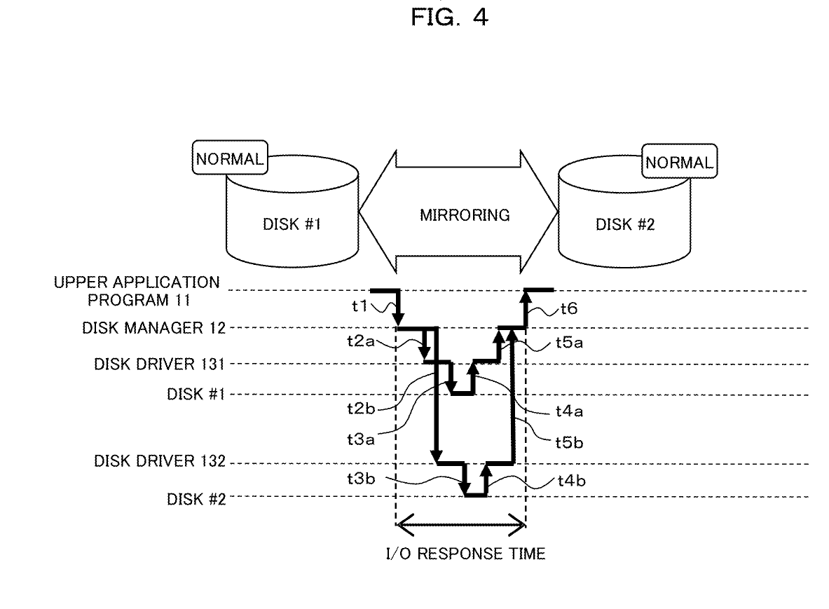

Next, description will now be made in relation to the operation of the information processing system including the server 1 of the first embodiment having the above configuration by referring to FIGS. 4-13.

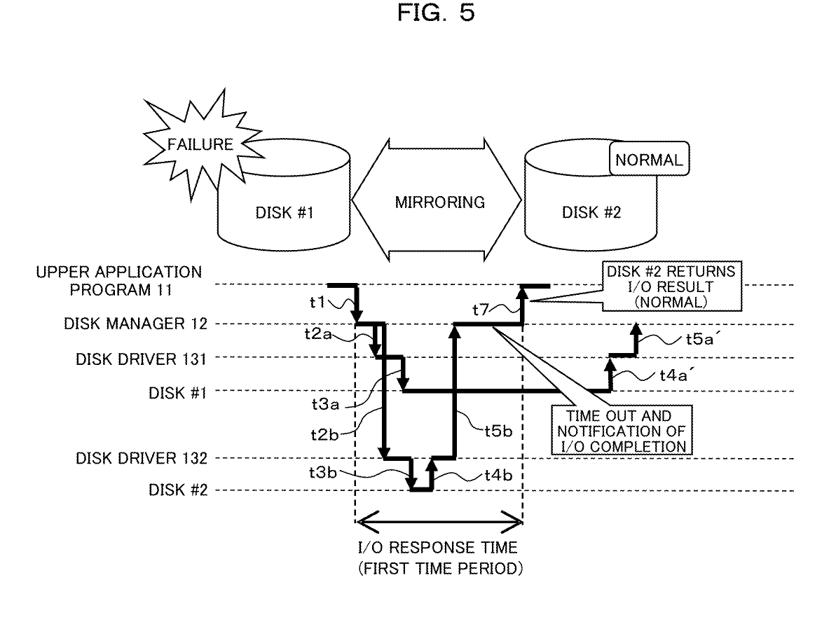

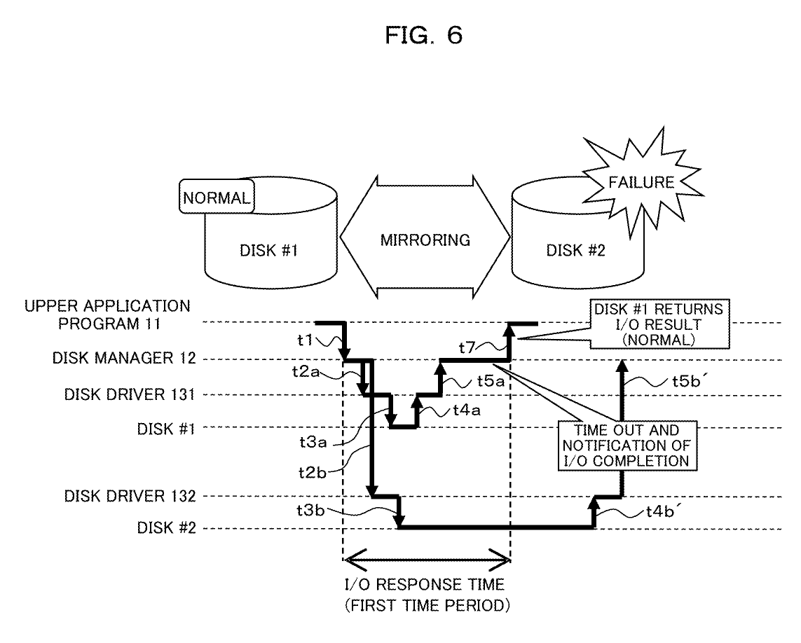

First of all, description will now be made in relation to basic operation of the server 1 of the first embodiment by referring to FIGS. 4-6. FIG. 4 is a diagram illustrating operation of the first embodiment when the two disks #1 and #2 configuring a redundant system are both normal; FIG. 5 is a diagram illustrating operation of the first embodiment when one (disk #1) of the two disks #1 and #2 configuring a redundant system has a failure; and FIG. 6 is a diagram illustrating operation of the first embodiment when the other (disk #2) of the two disks #1 and #2 configuring a redundant system has a failure.

As illustrated in FIG. 4, when the two disks #1 and #2 configuring a redundant system are both normal, the disk manager 12 (I/O controller 12a) receives an I/O request from the upper application program 11 (see the timing t1 of FIG. 4) and then carries out the following operation. Specifically, the disk manager 12 simultaneously or substantially simultaneously issues an I/O request to the two disks #1 and #2 via the disk drivers 131 and 132 and starts the I/O control on the two disks #1 and #2 (see timings t2a and t3a; timings t2b and t3b of FIG. 4). The timers for the disks #1 and #2 are started at the timings t2a and t2b, respectively, at which the count of the first time period is started.

In the example of FIG. 4, since the disks #1 and #2 are both normal, the disk manager 12 receives a process completion notification from both the disks #1 and #2 via the disk drivers 131 and 132 within the first time period (see timings t4a and t5a and timings t4b and t5b of FIG. 4). In responsive to the notification, the disk manager 12 (response processor 12b) outputs the completion response to the upper application program 11 (see timing t6 of FIG. 4). In this case, the I/O response time (the time interval between the timings t1 and t6) between the issue of the I/O request and the receipt of the completion response at the upper application program 11 is shorter than the first time period.

As illustrated in FIG. 5, when the disk #1 has a failure but the disk #2 is normal, the disk manager 12 carries out the following operation after receipt of an I/O request from the upper application program 11 (see timing t1 of FIG. 5). Specifically, the disk manager 12 simultaneously or substantially simultaneously issues an I/O request to the two disks #1 and #2 via the disk drivers 131 and 132, and starts the I/O control on the two disks #1 and #2 (see timings t2a and t3a; timings t2b and t3b of FIG. 5). The timers for the disks #1 and #2 are started at the timings t2a and t2b, respectively, at which the count of the first time period is started.

In the example of FIG. 5, since the disk #2 is normal, the disk manager 12 receives a process completion notification from the disk #2 via the disk driver 132 within the first time period (see timings t4b and t5b in FIG. 5). However, since disk #1 has a failure, the disk manager 12 does not receive the process completion notification from the disk #1 within the first time period until the time out of the count of the first time period.

In response to the notification, the response processor 12b outputs the completion response to the upper application program 11 (see timing t7 of FIG. 5). This means that, even when the process completion notification is not received from the disk #1, the receipt of the process completion notification from the disk #2 allows the response processor 12b to output the completion response notifying that the result of the requested I/O process is normal to the upper application program 11. In this case, the I/O response time (the time interval between the timings t1 and t7) between the issue of the I/O request and the receipt of the completion response at the upper application program 11 is equal to the first time period.

In the example of FIG. 5, the disk manager 12 receives the process completion notification from the disk #1 after the first time period has passed (see timings t4a′ and t5a′ of FIG. 5). If the disk manager 12 receives a process completion notification from the disk #1 after the first time period has passed likewise this case, the process performed by the restoration processor 12c is applied, which will be detailed below.

As illustrated in FIG. 6, when the disk #2 has a failure but the disk #1 is normal, the disk manager 12 carries out the following operation after receipt of an I/O request from the upper application program 11 (see timing t1 of FIG. 6). Specifically, the disk manager 12 simultaneously or substantially simultaneously issues an I/O request to the two disks #1 and #2 via the disk drivers 131 and 132, and starts the I/O control on the two disks #1 and #2 (see timings t2a and t3a; timings t2b and t3b of FIG. 6). The timers for the disks #1 and #2 are started at the timings t2a and t2b, respectively, at which the count of the first time period is started.

In the example of FIG. 6, since the disk #1 is normal, the disk manager 12 receives a process completion notification from the disk #1 via the disk driver 131 within the first time period (see timings t4a and t5a in FIG. 6). In contrast, since disk #2 has a failure, the disk manager 12 does not receive the process completion notification from the disk #2 within the first time period until the time out of the count of the first time period.

In response to the notification, the response processor 12b outputs a completion response to the upper application program 11 (see timing t7 of FIG. 6). This means that, even when the disk manager 12 does not receive the process completion notification from the disk #2, the receipt of the process completion notification from the disk #1 allows the response processor 12b to output the completion response notifying that the result of the requested I/O process is normal to the upper application program 11. In this case, the I/O response time (the time interval between the timings t1 and t7) between the issue of the I/O request and the receipt of the completion response at the upper application program 11 is equal to the first time period.

Also in the example of FIG. 6, the disk manager 12 receives the process completion notification from the disk #2 after the first time period has passed (see timings t4b′ and t5b′ of FIG. 6). If the disk manager 12 receives a process completion notification from the disk #2 after the first time period has passed likewise this case, the process by the restoration processor 12c is applied, which will be detailed below.

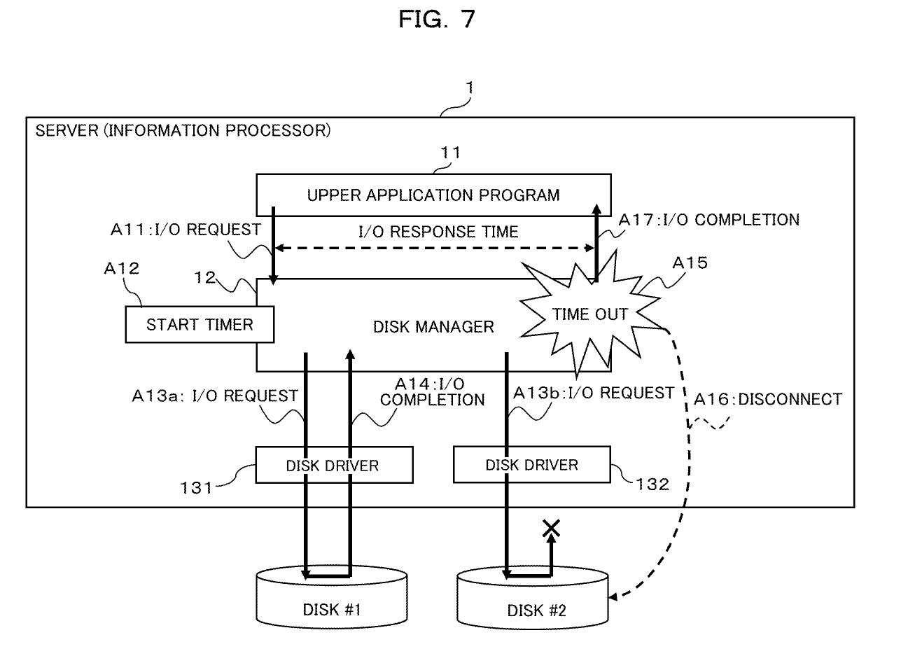

Next, detailed description will now be made in relation to the operation of the first embodiment when one (disk #2) of the two disks #1 and #2, configuring a redundant system, has a failure by referring to FIG. 7.

In the example of FIG. 7, the upper application program 11 issues an I/O request (see Arrow A11). Upon receipt of the I/O request from the upper application program 11, the disk manager 12 starts the timer that counts the first time period at the timing of starting corresponding I/O control (see reference number A12). Then the disk manager 12 (the I/O controller 12a) simultaneously or substantially simultaneously issues the I/O request to the two disks #1 and #2 via the disk drivers 131 and 132 (see Arrows A13a and A13b).

The disk driver 131 receives a process completion notification from the normal disk #1 and notifies the disk manager 12 of the I/O completion (see Arrow A14). In this case, the disk manager 12 results in receipt of the process completion notification from the disk #1 within the first time period. In contrast, the failure disk #2 is not allowed to reply with the process completion notification, so that the disk driver 132 and the disk manager 12 wait for the process completion notification from the disk #2.

When the first time period has passed to occur time out (see Arrow A15), the disk manager 12 disconnects the disk #2 from the mirroring (see Arrow A16) to change the disk #2 into the tentative fallback state. In response to the occurrence of the time out, the I/O controller 12a notifies the upper application program 11 of the completion response (see Arrow A17). In this case, the I/O response time (the time interval between Arrows A11 and A17) between the issue of the I/O request and the receipt of the I/O completion at the upper application program 11 is equal to the first time period.

The disk driver 132 performs I/O control on the disk #2, which has been changed into the tentative fallback state, for a second time period since the first time period has passed. For this purpose, the device driver 132 refers to the information related to the I/O request, which information is stored in the second memory regions 22a and 22b for the disk #2.

Next, detailed description will now be made in relation to the functions of the disk manager 12 to notify the upper application program 11 of a completion response upon receipt of the process completion notification from the one disk #1 without waiting for receipt of the process completion notification from the other disk #2.

When the upper application program 11 is issuing an I/O request, the upper application program 11 reserves the I/O request management information region 20a and the I/O buffer region 20b on the memory 20. The upper application program 11 stores management information including the I/O request itself into the region 20a and, if the I/O request is a writing request, stores, into the region 20b, data to be written. In usual cases, the disk manager 12 and the disk driver 13 perform I/O control on the disks #1 and #2, referring to the information stored in the regions 20a and 20b. Then, upon receipt of the notification of I/O completion from the disk manager 12, the upper application program 11 releases the regions 20a and 20b.

The disk manager 12 has to wait for the completion of all the I/O processes on the subordinate disk driver 13 and then notify the upper application program 11 of the I/O completion. If the disk manager 12 notifies the upper application program 11 of the I/O completion before receiving the process completion notification from the subordinate entity in response to the I/O request, the memory regions 20a and 20b are released even when these regions are being used in the subordinate disk driver 13 or the other entity. In this case, the disk driver 13 or the other subordinate entity accesses the released memory regions 20a and 20b, which has a possibility of hang-up or data corruption.

In order to avoid such inconvenience, the disk manager 12 of the first embodiment receives an I/O request from the upper application program 11 and then reserves the second memory regions 21a, 21b, 22a, and 22b, which are different from the regions 20a and 20b reserved by the upper application program 11 as usual. Providing that the issued I/O request directs two disks #1 and #2, the second memory regions 21a and 21b are reserved for the disk #1 and the second memory regions 22a and 22b are reserved for the disk #2. Specifically, the information stored in the first memory region 20a is copied into the second memory regions 21a and 22a and the information stored in the first memory region 20b are copied into the second memory regions 21b and 22b. After that, the I/O control on the subordinate driver 13 (131 and 132) is carried out using the information stored in the second memory regions 21a, 21b, 22a, and 22b without using information in the first memory regions 20a and 20b.

The above configuration allows the subordinate driver 13 and another entity to carry out process using information in the second memory regions 21a, 21b, 22a, and 22b different from the first memory regions 20a and 20b even when the first memory regions 20a and 20b are released. This means that even when the first memory regions 20a and 20b are released because the disk manager 12 notifies the upper application program 11 of the I/O completion without waiting for the process completion notification from the other disk, the subordinate driver 13 or another entity can continue the process using the second memory regions 21a, 21b, 22a, and 22b. This can prevent the disk driver 13 or another entity from accessing the released memory regions 20a and 20b, so that the possibility of hang-up and data corruption can be eliminated.

Under the presence of a disk that does not respond to the I/O request within the first time period, if the disk is fallen back (i.e., fallback of the mirroring configuration), the disk, which however has no failure, is sometimes disconnected. For example, when each disk is connected to the server 1 via multi-path, time out may occur while the failure path is replaced by a normal path and consequently, the disk may be disconnected.

As a solution to the above, the first embodiment temporarily changes a disk which does not issue the process completion notification within the first time period into the tentative fallback state, which is a state where, as described above as the state (14), the disk in question is disconnected from mirroring and is not a target for an I/O request, but has a possibility of recovering to a normal state. Under the presence of a disk made into the tentative fallback state, when data is written into the disk that is not in the fallback state and that is the counterpart of the disk in the tentative fallback state, the position information representing the position of the data writing (the position of updating) is recorded as the difference information into the bitmap 51 or 52.

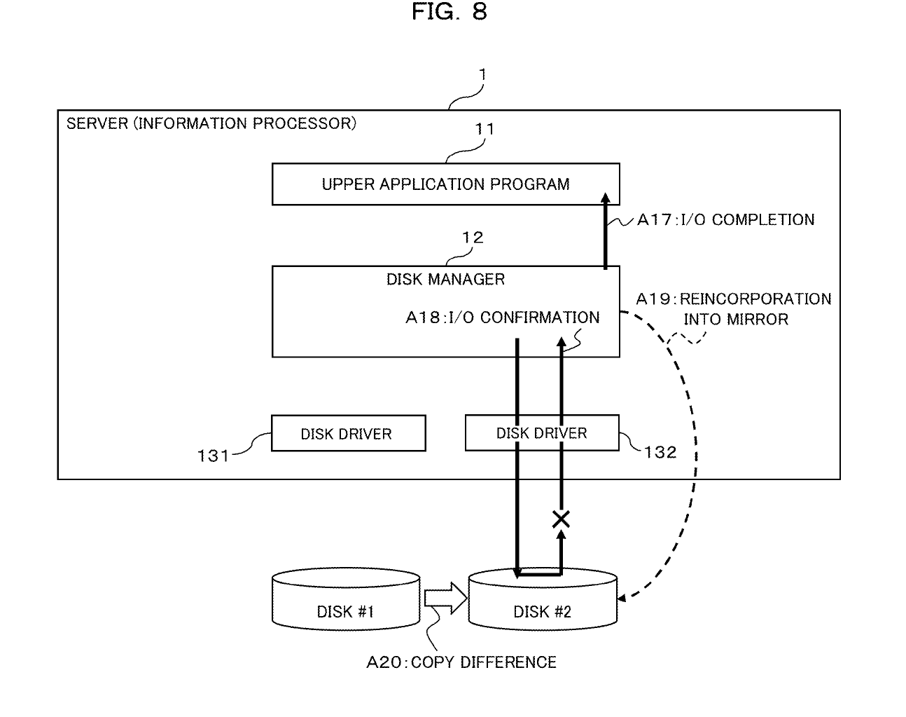

When the second time period further passed since the first time period has passed, the disk manager 12 operates as depicted in FIG. 8. FIG. 8 is a diagram specifically depicting an operation for restoring from tentative fallback of the first embodiment. In FIG. 8, the disk #1 is in the normal state and the disk #2 is in the tentative fallback state.

When the second time period has further passed after the notification of the I/O completion to the upper application program 11 (see Arrow A17), the disk manager (the restoration processor 12c) confirms whether all process completion notifications responsive to the I/O requests are received from the disk #2 in the tentative fallback state (see Arrow A18). If all the process completion notifications are received, the restoration processor 12c restores the disk #2 from the tentative fallback state to the copying state (normal state) and reincorporates the disk #2 into the mirror (see Arrow A19). After that, the restoration processor 12c refers to the bitmap 51 for the disk #1 and copies the data (difference data) of the updated position from the disk #1 into the disk #2 (see Arrow A20), so that the mirroring state between the disk #1 and the disk #2 is restored.

On the other hand, if all the process completion notifications are not received as the result of the confirmation, the restoration processor 12c changes the disk #2 from the tentative fallback state into the fallback state. Besides, the restoration processor 12c stops recording the updated position of the disk #1 and sets all the bits in the bitmap (difference information) 51 for the disk #1 to be “0” and thereby clears the bitmap (difference information) 51 for the disk #1.

Setting the first time period to be short in order to rapidly reply to the upper application program 11 with I/O completion has a possibility of falling back the normal disk #2, which is simply in delay of the process completion notification due to path change but which has no failure. In the first embodiment, reconfirmation is made as to whether the disk #2 in the tentative fallback state issued the process completion notification at the time when the second time period passed since the first time period had passed, and if the disk manager 12 receives the process completion notification from the disk #2, the disk manager 12 restores the disk #2 from the tentative fallback state, so that the mirroring between the disks #1 and #2 are also restored. This can avoid the circumstance where a short first time period disconnects a normal disk and can effectively use the normal disk.

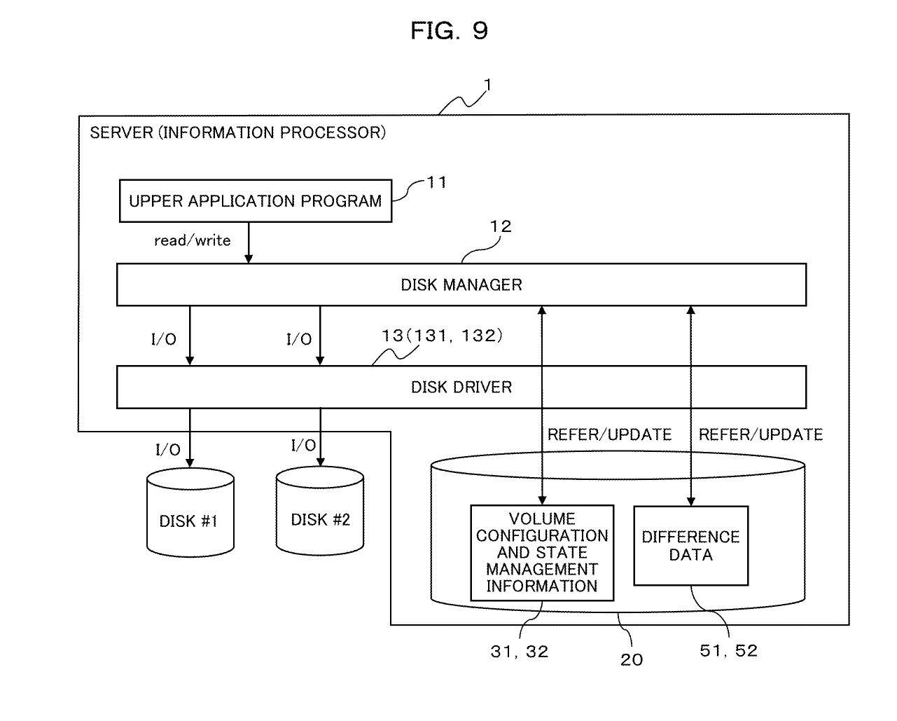

Next, description will now be made in relation to operation of the disk manager 12 by referring to FIGS. 9-13.

As illustrated in FIG. 9, in the server 1 of the first embodiment, the disk manager 12 performs I/O control simultaneously on the two disks #1 and #2, which configure a redundant system, in accordance with an I/O request (reading request or writing request) from the upper application program 11. In this event, the disk manager 12 carries out the following operation depicted in flow diagrams of FIGS. 10-13 by referring to and updating the volume configuration and state management information 31 and 32 and the difference information 51 and 52 stored in the memory 20 (or the disks #1 and #2). FIG. 9 is a block diagram schematically depicting the operation performed by the disk manager 12 of the first embodiment.

Firstly, description will now be made in relation to a process (by the I/O controller 12a) of issuing an I/O request to the disk driver 13 (the disks #1 and #2) by referring to the flow diagram (steps S11-S17) of FIG. 10. When the I/O request is a writing request, the process of issuing an I/O request is separately carried out on each of the two disks #1 and #2, which configure a redundant system. The process of issuing an I/O request to the two disks #1 and #2 may be simultaneously carried out in parallel or may be substantially simultaneously carried out in series. In contrast, when the I/O request is a reading request, the process of issuing an I/O request is carried out on selected one of the two disks, which will be detailed below by referring to FIG. 12.

The disk manager 12 reserves the I/O request management information region 21a or 22a for the disk #1 or #2, which is different from the memory regions 20a and 20b reserved by the upper application program 11, in accordance with the I/O request from the upper application program 11 (step S11). Then, the disk manager 12 copies management information (including the I/O request from the upper application program 11) stored in the I/O request management information region 20a for application into the reserved region 21a or 22a (step S12).

In accordance with the I/O request from the upper application program 11, the disk manager 12 further reserves the I/O buffer region 21b or 22b for the disk #1 or #2, which is different from the memory regions 20a and 20b reserved by the upper application program 11 (step S13). When the I/O request is a writing request, the disk manager 12 further copies data to be written (data being received from the upper application program 11 and being stored in the I/O buffer) stored in the I/O buffer region 20b for application into the reserved region 21b or 22b (step S14). In contrast, the I/O request is a reading request, the reserved regions 21b and 22b are to be used for storing data read from the disk #1 or #2 and therefore step S14 is skipped.

After that, the disk manager 12 starts the timer function to count the first time period (step S15). The timer function is started for each disk and the first time period is counted for each disk.

At the timing of starting the respective timer functions, the I/O controller 12a issues the I/O request to the two disks #1 and #2 via the disk driver 13 referring to the regions 21a, 22a, 21b, and 22b of the memory 20, and thereby starts the I/O control (step S16). Although the timer function for each disk is started before the start of the I/O control in FIG. 10, the timer function may alternatively be started after the start of the I/O control or concurrently with the start of the I/O control. Then the disk manager 12 waits for an I/O response (process completion notification) from the disk driver 13 (disks #1 and #2) (step S17).

Next, description will now be made in relation to operation of the disk manager 12 during the process of wiring of the first embodiment by referring to flow diagram (steps S21-S33) of FIG. 11.

When the I/O request form the upper application program 11 is a writing request, the process of issuing an I/O request of FIG. 10 is carried out on the two disks #1 and #2 and the disk manager 12 comes into a state of waiting for an I/O response from the disk driver 13 (the disks #1 and #2). To deal with the writing request, the disk manager 12 in the waiting state successively carries out the process depicted in FIG. 11. The following description to be made with reference to FIG. 11 assumes that the disk #1 first issues an I/O response among the two disks #1 and #2 and the disk #2 is regarded as the other disk.

The disk manager 12 (the I/O controller 12a and the response processor 12b), which comes into waiting state (i.e., standby for writing process), determines whether or not a process completion notification from the disk #1 (the disk driver 131) has been received (step S21). Upon receipt of the process completion notification from the disk #1 (YES route of step S21), the disk manager 12 writes an I/O process result (process completion) into the I/O request management information region 21a for the disk #1. Then the disk manager 12 copies the I/O process result stored in the I/O request management information region 21a for the disk #1 into the I/O request management information region 20a for application (step S22).

An example of information related to the process completion notification is flag information that is to be changed from “0” to “1” when the process completion notification is received. At the time of the completion of step S22, the flag information in the I/O request management information region 20a for application and the I/O request management information region 21a for the disk #1 are both changed into “1” but the flag information in the I/O request management information region 22a for the disk #2 remains to be “0”.

The disk manager 12 determines whether the timer function for the disk #2 has counted the first time period, that is, whether or not the time out for the I/O process occurs in the disk #2 (step S23). If time out does not occur in the disk #2 (NO route in step S23), the disk manager 12 further determines whether or not the process responsive to the I/O request to the disk #2 is normally completed (step S24).

When the process responsive to the I/O request to the disk #2 is normally completed before the first time period has passed (YES route in step S24), the disk manager 12 releases the memory regions 22a and 22b reserved for the disk #2 (step S25). Further, the disk manager 12 releases the memory regions 21a and 21b reserved for the disk #1 (step S26).

After that, the disk manager 12 determines whether or not a disk in the tentative fallback state is present by referring to, for example, the volume configuration and state management information 31 and 32 in the regions 21c and 22c of the memory 20 (step S27). Here, the disk manager 12 determines whether the disk #2, which is the mirroring counterpart of the disk #1, is in the tentative fallback state.

When the process reaches step S27 through the YES route of step S24 via steps S25 and S26, the disk manager 12 determines that the disk #2 is in the normal state and no disk in the tentative fallback state is present (NO route in step S27) and the response processor 12b notifies the upper application program 11 of I/O completion (step S28). Upon receipt of the I/O completion notification, the upper application program 11 refers to the flag information “1” in the I/O request management information region 20a for application and then releases the regions 20a and 20b in the memory 20.

When the process responsive to the I/O request to the disk #2 is not normally completed before the first time period passes (No route in step S24), the disk manager 12 changes the disk #2 into the fallback state. Furthermore, the disk manager 12 changes the states in the volume configuration and state management information 32 for the disk #2 in the regions 22c and 42a both from the normal state to the fallback state (step S29) and then moves to step S25.

When the process reaches step S27 through the NO route of step S24 via steps S29, S25, and S26, the disk manager 12 determines that the disk #2 is in the fallback state and no disk in the tentative fallback state is present (NO route in step S27) and the response processor 12b notifies the upper application program 11 of I/O completion (step S28). In this event, the flag information in the I/O request management information region 22a for the disk #2 remains to be “0”. Upon receipt of the I/O completion notification, the upper application program 11 refers to the flag information “1” in the I/O request management information region 20a for application and then releases the regions 20a and 20b in the memory 20.

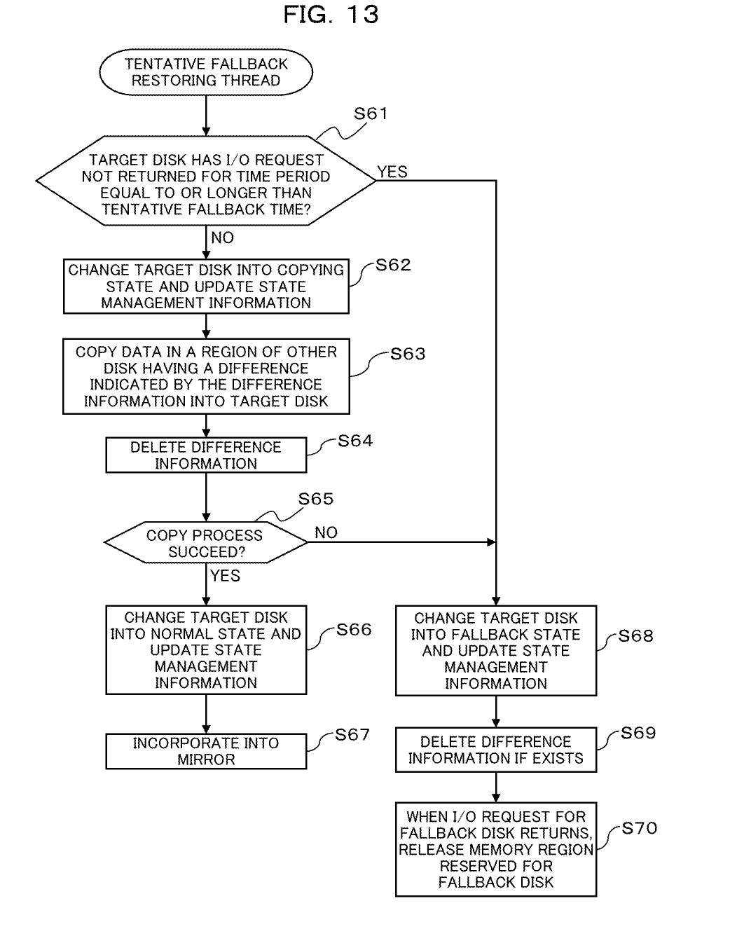

If time out occurs in the disk #2 (YES route in step S23), the disk manager 12 starts the timer function to count the second time period (step S30). The disk manager 12 further changes the disk #2 into the tentative fallback state and updates the states of the volume configuration and state management information 32 for the disk #2 in the regions 22c and 42a both from the normal state to the tentative fallback state (step S31). The disk manager 12 starts a tentative fallback restoring thread (see FIG. 13) of the restoration processor 12c (step S32) and moves to step S26.

During the time period from the start of the tentative fallback restoring thread at step S32 to the completion of the thread, the process on restoring from the tentative fallback on the disk #2 and a process for the other disk #1 are carried out independently of and in parallel with each other. During this time period, even when the data in the disk #1 is updated, the updating is not reflected in the disk #2 and an I/O process is carried only on the disk #1. However, when the data in the disk #1 is updated, the position information representing the updated position is recorded as the difference information in the bitmap 51.

When the process reaches step S27 through the YES route of step S23 via steps S30-S32, and S26, the disk manager 12 determines that the disk #2 is in the tentative fallback state and a disk in the tentative fallback state is present (YES route in step S27). In this case, the disk manager 12 records the position information representing the region rewritten in response to the writing request to the disk #1 in the difference information (bitmap) 51 (step S33). Then, the response processor 12b notifies the upper application program 11 of I/O completion (step S28). In this event, the flag information in the I/O request management information region 22a for the disk #2 remains to be “0”. Upon receipt of the I/O completion notification, the upper application program 11 refers to the flag information “1” in the I/O request management information region 20a for application and then releases the regions 20a and 20b in the memory 20.

The description of process performed when an I/O error occurs in the disk #1, which first issues an I/O response, is omitted here. In this event, the remaining disk #2 is the last disk and therefore is not changed into the tentative fallback state, so that a normal process for an I/O error is carried out.

Next, description will now be made in relation to operation of the disk manager 12 during a reading process of the first embodiment by referring to a flow diagram (steps S41-S60) of FIG. 12.

Upon receipt of a reading request, as the I/O request, from the upper application program 11 (YES route in step S41), the disk manager 12 selects the disk to be read in response to the reading request (step S42). The disk manager 12 executes the process of issuing an I/O request (see FIG. 10) to a disk driver corresponding to the selected disk (step S43). This starts the timer function for the selected disk to count the first time period and the disk manager 12 waits for an I/O response (process completion notification) from the disk driver 13.

The disk manager 12 (the I/O controller 12a and the response processor 12b) on standby for reading process, determines whether or not the timer function for the selected disk has counted the first time period, that is, whether or not time out of the I/O process occurs in the selected disk (step S44). When time out does not occur in the selected disk (NO route of step S44), the disk manager 12 determines whether or not the process for the I/O request to the selected disk is normally completed (step S45).

When the process responsive to the I/O request to the selected disk is normally completed before the first time period has passed (YES route in step S45), the flag information “1” representing that the I/O process result is process completion is written into the I/O request management information region for the selected disk. In the I/O buffer region for the selected disk, data read from the selected disk is written to be the I/O process result. The disk manager 12 copies the process completion information in the I/O request management information region for the selected disk into the I/O request management information region 20a for application and also copies the read data in the I/O buffer region for the selected disk into the I/O buffer region 20b for application (step S46).

After that, the disk manager 12 releases the memory regions reserved for the selected disk (step S47) and the response processor 12b notifies the upper application program 11 of the I/O completion (step S48). Upon receipt of the I/O completion notification, the upper application program 11 refers to the flag information “1” in the I/O request management information region 20a for application and then releases the regions 20a and 20b in the memory 20.

When the process responsive to the I/O request to the selected disk is not normally completed before the first time period has passed (NO route in step S45), the disk manager 12 changes the selected disk into the fallback state. Then, the disk manager 12 changes the state of the volume configuration and state management information for the selected disk from the normal state into the fallback state (step S49) and also releases the memory region reserved for the selected disk (step S50).

After that, the disk manager 12 selects the other disk, which is the mirroring counterpart of the selected disk (step S51), and further executes the process of issuing an I/O request (see FIG. 10) to the disk driver corresponding to the other disk (step S52). Description of the process performed in the event of double failure, which means that time out of the I/O process occurs also on the other disk is omitted here because a normal process for an I/O error is executed in this case.

Then the disk manager 12 determines whether or not the process in accordance with the I/O request to the other disk is normally completed (step S53). When the process according to the I/O request to the other disk is normally completed (YES route in step S53), the flag information “1” representing the process completion as the I/O process result is written in the I/O request management information region for the other disk. The data read from the other disk is written to be the I/O process result in the I/O buffer region for the other disk. The disk manager 12 copies the process completion information in the I/O request management information region for the other disk into the I/O request management information region 20a for application and also copies the read data in the I/O buffer region for the other disk into the I/O buffer region 20b for application (step S54).

Then, the disk manager 12 releases the memory regions reserved for the other disk (step S55), and the response processor 12b notifies the upper application program 11 of the I/O completion (step S48). Upon receipt of I/O completion notification, the upper application program 11 refers to the flag information “1” in the I/O request management information region 20a for application and then releases the regions 20a and 20b in the memory 20.

In contrast, when the process according to the I/O request to the other disk is not normally completed (NO route in step S53), the disk manager 12 releases a memory regions reserved for the other disk (step S56) and the response processor 12b notifies the upper application program 11 of an I/O error (step S57).

When time out occurs in the selected disk (YES route of step S44), the disk manager 12 starts the timer function to count the second time period (step S58). Then the disk manager 12 changes the selected disk into the tentative fallback state and also changes the state of the volume configuration and state management information for the selected disk from the normal state to the tentative fallback state (step S59). In addition, the disk manager 12 starts the tentative fallback restoring thread (see FIG. 13) of the restoration processor 12c (step S60) and moves to step S51.

During the time period from the start of the tentative fallback restoring thread at step S60 to the completion of the thread, the process for restoring from the tentative fallback on the selected disk and a process on the remaining disk (i.e., the other disk) are carried out independently of and in parallel with each other. During this time period, even when the data in the other disk is updated, the updating is not reflected in the selected disk and an I/O process is carried only on the other disk. However, when the data in the other disk is updated, the position information representing the updated position is recorded in the difference information (bitmap).

Next, description will now be made in relation to the procedure of processing the tentative fallback restoring thread (by the restoration processor 12c) of the first embodiment by referring to the flow diagram (steps S61-S70) of FIG. 13.

When the tentative fallback restoring thread is started in step S32 of FIG. 11 or step S60 of FIG. 12, the restoration processor 12c starts its operation. First of all, the restoration processor 12c determines whether or not the target disk (here assumed to be the disk #2) has an I/O request not returned for a time period equal to or longer than the second time period (tentative fallback time) (step S61). Here, “an I/O request not returned” means that the disk #2 has not replied to the disk manager 12 with the process completion notification in response to the I/O request.

When the disk #2 has no I/O request not returned for a time period equal to or longer than the second time period (NO route in step S61), that is, when the disk #2 has issued process completion notifications in response to all the I/O requests to the disk #2, the restoration processor 12c carries out the following process.

Specifically, the restoration processor 12c restores the disk #2 from the tentative fallback state to the copying state, and updates the state in the volume configuration and state management information 32 for the disk #2 from the tentative fallback state to the copying state (step S62). Here, the copying state of the disk #2 means a state where the disk #2 is connected to the mirroring counterpart disk #1 in the normal state via the FC-SW 3 and the server 1 (i.e., the disk manager 12) and data can be copied from the disk #1 into the disk #2.

The restoration processor 12c refers to the bitmap 51 for the other disk (here assumed to be the disk #1, which is the mirroring counterpart of the disk #2) and copies data (difference data) in the updated position from the disk #1 into the disk #2 (step S63), so that the mirroring state between the disk #1 and the disk #2 is restored.

After that, the restoration processor 12c deletes the difference information (bitmap) 51 (step S64), and determines whether or not the copy process in step S63 has succeeded (step S65). If the copy process succeeded (YES route in step S65), the restoration processor 12c changes the disk #2 from the copying state into the normal state and also updates the volume configuration and state management information 32 for the disk #2 from the copying state to the normal state (step S66). Then the disk #2 is incorporated in the system (step S67) and thereby the disks #1 and #2 configure the mirroring system.

On the other hand, when the copy process has failed (NO route in step S65) or when the disk #2 have an I/O request not returned for a time period equal to or longer than the second time period (YES route in step S61), the restoration processor 12c carries out the following process.

Specifically, the restoration processor 12c changes the disk #2 from the tentative fallback state into the fallback state and also changes the state in the volume configuration and state management information 32 for the disk #2 from the tentative fallback state into the fallback state (step S68). When the disk #1, which is the counterpart of the disk #2, has the difference information (bitmap) 51, the restoration processor 12c deletes the difference information (bitmap) 51 (step S69).

After that, if the I/O request to the fallback disk #2 is returned, the disk manager 12 releases the memory regions 22a and 22b reserved on the memory 20 for the fallback disk #2 (step S70).

(3) Effects of the First Embodiment:

As described above, when the I/O control simultaneously carried out on the two disks #1 and #2 in the server 1 of the first embodiment results in receiving a process completion notification from one of the disks within the first time period after the start of the I/O control but not receiving the process completion notification from the other disk, the disk manager 12 determines that a failure occurs in the other disk.

Consequently, the disk manager 12 falls back the mirroring and notifies the upper application program 11 of I/O completion. This can suppress the I/O response time to the first time period appropriately set by a user or an operator, so that the I/O response time can be greatly reduced.

Consequently, the process completion response to the I/O control requested from the upper application program 11 can be speeded up, and the time occupied by the I/O control requested from the upper application program 11 can be greatly reduced. This rapid process completion response can be achieved by the server 1 (i.e., the disk manager 12), which is the upper side of the disks, without modifying the configuration of the disks. The response time can be greatly reduced irrespectively of the type of disk driver and the hardware performance (times for retrying and cancelling).

In the server 1 of the first embodiment, even after the first memory regions 20a and 20b for the upper application program 11 are released, the subordinate driver 13 and another entity can carry out the process using the second memory regions 21a, 21b, 22a, and 22b, which are different from the first memory regions 20a and 20b. In other words, the disk manager 12 notifying the upper application program 11 of I/O completion without waiting for a process completion notification allows, even when the first memory regions 20a and 20b are released, the subordinate driver 13 and the other entity to continue the process, using the second memory regions 21a, 21b, 22a, and 22b. This can prevent the disk driver 13 or another entity from accessing the released memory regions 20a and 20b, which can eliminate the possibility of hang-up or data corruption.

Setting the first time period to be short in order to rapidly reply to the upper application program 11 with an I/O completion has a possibility of falling back the normal disk #2, which is simply in delay of the process completion notification due to path change but which has no failure. In the server 1 of the first embodiment, reconfirmation is made as to whether the disk #2 in the tentative fallback state issued the process completion notification at the time when the second time period further passed since the first time period had passed, and if the disk manager 12 receives the process completion notification, the disk #2 is restored from the tentative fallback state to the normal state. In this event, the difference data based on the difference information (bitmaps) 51 and 52 are copied from the disk #1 to the disk #2 and the mirroring state between the disk #1 and the disk #2 is also restored, so that the redundant configuration can be continued.

(4) First Modification to the First Embodiment:

In the above first embodiment, when the I/O control simultaneously carried out on the two disks #1 and #2 results in receiving a process completion notification from one of the disks within the first time period after the start of the I/O control but not receiving the process completion notification from the other disk, a completion response is issued to the upper application program 11. However, the present invention is by no means limited to this.

Alternatively, when receiving a process completion notification from one disk (first storing device) as a result of I/O control simultaneously performed on two disks, the process completion response may be immediately issued in accordance of the I/O request to the upper application program 11 in the first modification. Thereby, the first modification can reply with the process completion response more rapidly than the first embodiment, so that the process completion response to the I/O control requested from the upper application program 11 can be more rapidly issued.

The first modification may count the first time period after the start of the I/O control and, when the process completion notification is received from neither of the two disks within the first time period, the response processor 12b may determine that double failure occurs and issue an I/O error to the upper application program 11.

Also in the first modification, the count of the second time period may be started at the time when the disk manager 12 issues the completion response to the upper application program 11. In this case, when the process completion notification is received from the other disk (second storing device) within the second time period after the issue of the completion response to the upper application program 11, the restoration processor 12c carries out the operation likewise the first embodiment.

Specifically, the restoration processor 12c restores the other disk from the tentative fallback state and then copies the difference data corresponding to each bit in the bitmaps 51 and 52 set to be “1” from the one disk to the other disk, so that the mirroring state between the two disks is also restored. At that time, the state in the volume configuration and state management information 31 or 32 for the other disk is updated from the tentative fallback state to the normal state. On the other hand, when a process completion notification is not received from the other disk within the second time period after the completion response is output to the upper application program 11, the restoration processor 12c changes the other disk from the tentative fallback state to the fallback state. At that time, the state in the volume configuration and state management information 31 or 32 for the other disk is updated from the tentative fallback state to the fallback state.

Consequently, the first modification can obtain the same advantageous effects as those of the above first embodiment.

(5) others:

A preferred embodiment is described as the above. However, the present invention is not limited to the above embodiment, and various changes and modifications can be suggested without departing from the spirit of the present invention.

For example, description of the first embodiment assumes that the I/O control in accordance with the I/O request from the upper application program 11 is simultaneously carried out on two disks (storing devices), but the number of target disks is not limited to two. The present invention can be applied to cases where three or more disks are simultaneously subjected to I/O control likewise the first embodiment and these cases can obtain the same advantageous effects as those of the first embodiment.

The above first embodiment assumes the targets of an I/O request from the upper application program 11 are disks (HDDs) in the storing devices 2, but the present invention is not limited to this. Alternatively, the targets of an I/O request may be various storing medium such as SSDs.

The above embodiment makes it possible to rapidly issue a process completion response to the I/O control requested from the upper application program, so that the time occupied by the I/O control by the upper application program can be shortened.

All examples and conditional language provided herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processor comprising:
an input/output (I/O) controller that simultaneously performs first I/O control on a plurality of storing devices, which configure a redundant system, in accordance with a first I/O request from an upper application; and
a response processor that outputs, when the response processor receives a process completion notification from a first storing device that is one of the plurality of storing devices as a result of the first I/O control simultaneously performed on the plurality of storing devices, a completion response representing completion of a process related to the first I/O request to the upper application.

2. The information processor according to claim 1, wherein the response processor outputs, when the response processor receives the process completion notification from the first storing device within a first time period after starting the first I/O control and does not receive a process completion notification from a second storing device that is different from the first storing device and that is one of the plurality of storing devices within the first time period, the completion response to the upper application.

3. The information processor according to claim 2, wherein
the I/O controller
reserves a plurality of second memory regions, prepared one for each of the plurality of storing devices, the plurality of second memory regions being different from a first memory region in which the first I/O request from the upper application is processed;
copies information related to the first I/O request from the first memory region to the plurality of second memory regions; and
performs the first I/O control on the plurality of storing devices using the information related to the first I/O request in the plurality of second memory regions.

4. The information processor according to claim 3, wherein
the I/O controller
performs the first I/O control on the second storing device, being switched into a tentative fallback state after the first time period has passed, using the information related to the first I/O request stored in the second memory region prepared for the second storing device while performs, using information being related to a second I/O request newly issued from the upper application and being stored in the second memory region prepared for the first storing device, second I/O control on the first storing device in accordance with the second I/O request; and
when the second I/O control responsive to the second I/O request is related to a writing access, records position information representing a position having undergone the writing access in the first storing device, as difference information, into a difference information managing region.

5. The information processor according to claim 4, further comprising a restoration processor that restores, upon receipt of the process completion notification from the second storing device within a second time period after the first time period has passed, the second storing device from the tentative fallback state and copies difference data from the first storing device to the second storing device, the difference data corresponding to the difference information recorded in the difference information managing region.

6. The information processor according to claim 5, wherein the restoration processor changes, when not receiving the process completion notification from the second storing device within the second time period since the first time period has passed, the second storing device from the tentative fallback state into a fallback state.

7. A non-transitory computer-readable recording medium having stored therein an input/output (I/O) controlling program for causing a computer to execute a process comprising:
simultaneously performing first I/O control on a plurality of storing devices, which configure a redundant system, in accordance with a first I/O request from an upper application; and
outputting, when receiving a process completion notification from a first storing device that is one of the plurality of storing devices as a result of the first I/O control simultaneously performed on the plurality of storing devices, a completion response representing completion of a process related to the first I/O request to the upper application.

8. The non-transitory computer-readable recording medium according to claim 7, wherein the process further comprises outputting, when receiving the process completion notification from the first storing device within a first time period after starting the first I/O control and not receiving a process completion notification from a second storing device that is different from the first storing device and that is one of the plurality of storing devices within the first time period, the completion response to the upper application.

9. The non-transitory computer-readable recording medium according to claim 8, wherein the process further comprises:
reserving a plurality of second memory regions, prepared one for each of the plurality of storing devices, the plurality of second memory regions being different from a first memory region in which the first I/O request from the upper application is processed;
copying information related to the first I/O request from the first memory region to the plurality of second memory regions; and
performing the first I/O control on the plurality of storing devices using the information related to the first I/O request in the plurality of second memory regions.

10. The non-transitory computer-readable recording medium according to claim 9, wherein the process further comprises:
performing the first I/O control on the second storing device, being switched into a tentative fallback state after the first time period has passed, using the information related to the first I/O request stored in the second memory region prepared for the second storing device, while performing, using information being related to a second I/O request newly issued from the upper application and being stored in the second memory region prepared for the first storing device, second I/O control on the first storing device in accordance with the second I/O request; and
when the second I/O control responsive to the second I/O request is related to a writing access, recording position information representing a position having undergone the writing access in the first storing device, as difference information, into a difference information managing region.

11. The non-transitory computer-readable recording medium according to claim 10, wherein the process further comprises restoring, upon receipt of the process completion notification from the second storing device within a second time period since the first time period has passed, the second storing device from the tentative fallback state and copies difference data from the first storing device to the second storing device, the difference data corresponding to the difference information recorded in the difference information managing region.

12. The non-transitory computer-readable recording medium according to claim 11, wherein the process further comprises changing, when not receiving the process completion notification from the second storing device within the second time period since the first time period has passed, the second storing device from the tentative fallback state into a fallback state.

13. A method for input/output (I/O) controlling comprising:
by a computer
simultaneously performing first I/O control on a plurality of storing devices, which configure a redundant system, in accordance with a first I/O request from an upper application; and
outputting, when receiving a process completion notification from a first storing device that is one of the plurality of storing devices as a result of the first I/O control simultaneously performed on the plurality of storing devices, a completion response representing completion of a process related to the first I/O request to the upper application.

14. The method according to claim 13, further comprising
by the computer
outputting, when receiving the process completion notification from the first storing device within a first time period after starting the first I/O control and not receiving a process completion notification from a second storing device that is different from the first storing device and that is one of the plurality of storing devices within the first time period, the completion response to the upper application.

15. The method according to claim 14, further comprising
by the computer
reserving a plurality of second memory regions, prepared one for each of the plurality of storing devices, the plurality of second memory regions being different from a first memory region in which the first I/O request from the upper application is processed;
copying information related to the first I/O request from the first memory region to the plurality of second memory regions; and
performing the first I/O control on the plurality of storing devices using the information related to the first I/O request in the plurality of second memory regions.

16. The method according to claim 15, further comprising
by the computer
performing the first I/O control on the second storing device, being switched into a tentative fallback state after the first time period has passed, using the information related to the first I/O request stored in the second memory region prepared for the second storing device, while performing, using information being related to a second I/O request newly issued from the upper application and being stored in the second memory region prepared for the first storing device, second I/O control on the first storing device in accordance with the second I/O request; and
when the second I/O control responsive to the second I/O request is related to a writing access, recording position information representing a position having undergone the writing access in the first storing device, as difference information, into a difference information managing region.

17. The method according to claim 16, further comprising
by the computer
restoring, upon receipt of the process completion notification from the second storing device within a second time period after the first time period has passed, the second storing device from the tentative fallback state and copies difference data from the first storing device to the second storing device, the difference data corresponding to the difference information recorded in the difference information managing region.

18. The method according to claim 17, further comprising
by the computer
changing, when the computer does not receive the process completion notification from the second storing device within the second time period since the first time period has passed, the second storing device from the tentative fallback state into a fallback state.
